(19) United States
(12) Patent Application Publication
(10) Pub. No.: US 2026/0039379 A1
(43) Pub. Date: Feb. 5, 2026

(54) OPTICAL TRANSMISSION SYSTEM AND OPTICAL PATH SETTING/CONGESTION CONTROL METHOD

(71) Applicant: NTT, Inc., Tokyo (JP)

(72) Inventors: Kazuya ANAZAWA, Musashino-shi, Tokyo (JP); Takeru INOUE, Musashino-shi, Tokyo (JP); Hideki Nishizawa, Musashino-shi, Tokyo (JP); Toru MANO, Musashino-shi, Tokyo (JP); Kazuaki OBANA, Musashino-shi, Tokyo (JP); Koichi Takasugi, Musashino-shi, Tokyo (JP); Shigeru IWASHINA, Musashino-shi, Tokyo (JP)

(21) Appl. No.: 18/995,220

(22) PCT Filed: Jul. 27, 2022
(86) PCT No.: PCT/JP2022/029011

§ 371 Date: Jan. 16, 2025

(51) Int. Cl. H04B 10/073; H04B 10/077

(52) U.S. Cl. CPC H04B 10/0731; H04B 10/0773; H04B 10/0775

(57) ABSTRACT

There is provided an optical transmission system including a connection device 1 and a control device 2. The connection device 1 includes a fixed number of measurement devices 12 that measure a quality of a transmission line between a user terminal 3 and the connection device, a notification device 13 that notifies the user terminal of busy information, and a switching device 11 that switches a connection destination of the user terminal 3 to any one of: one of the fixed number of the measurement devices 12; the notification device 13; and the optical transmission network. The control device 2 includes a control unit 21 that controls the switching device 11. The control unit 21 detects a connection request from the user terminal 3, and in a case where a measurement device 12 of the fixed number of measurement devices 12 is available, connects the user terminal 3 to the available measurement device 12, in a case where none of the fixed number of measurement devices 12 is available, temporarily connects the user terminal 3 to the notification device 13, and when a measurement device of the fixed number of measurement devices has become available, connects the user terminal 3 to the available measurement device 12, and after the quality of the transmission line is measured by the connected measurement device 12, connects the user terminal 3 to the optical transmission network.

### TECHNICAL FIELD

The present invention relates to an optical transmission system and an optical path setting/congestion control method.

### BACKGROUND ART

In recent years, the application and spread of digital coherent optical transmission techniques have rapidly progressed. In a case where digital techniques are applied to an optical transmission device, in addition to increasing the transmission capacity and transmission distance, it is also possible to simplify a configuration of a system including transmission lines and to reduce a cost for the system configuration, through an adaptive compensation technique for transmission line characteristics (Non Patent Literature 1). Thereby, the size and cost of the transceiver itself has been reduced, and even users other than carriers can easily obtain an optical transmission device.

In addition, the optical transmission field is becoming more open, and open hardware and software are becoming available. As an example of hardware (transponder), there is a white box type optical transmission device in which hardware and software are separated. As an example of software, there is an open Network OS that can be mounted on a white box type optical transmission device (Non Patent Literatures 2 to 4). By utilizing open hardware and software, users other than carriers can prepare an optical transmission device, and construct a transmission network for their own services/in-house services (Non Patent Literature 5).

Due to such simplification, cost reduction, and opening in the optical transmission field, in the future, a case where users other than carriers (for example, service providers such as data center operators) prepare their own optical transmission device and perform end-to-end λ-connection (optical path connection) between user locations may be considered. At that time, it is assumed that the carriers need to accommodate the optical paths of the users outside the carrier network and perform A-connection in an optimum transmission mode (Non Patent Literatures 6 and 7).

### CITATION LIST

### Non Patent Literature

Non Patent Literature 1: H. Nishizawa, seven others, “Open whitebox architecture for smart integration of optical networking and data center technology”, Journal of Optical Communications and Networking, Vol.13, No.1 Jan. 2021 A78-A87
Non Patent Literature 2: “TAI (Transponder Abstraction Interface)”, Telecominfraproject/oopt-tai, [online], retrieved on Jun. 28, 2022, <URL: https://github.com/Telecominfraproject/oopt-tai>
Non Patent Literature 3: “Goldstone”, Telecominfraproject/oopt-goldstone, [online], retrieved on Jun. 28, 2022, <URL: https://github.com/Telecominfraproject/oopt-goldstone>
Non Patent Literature 4: V. Lopez, five others, “Enabling fully programmable transponder white boxes”, Journal of Optical Communications and Networking, Vol.12, No.2, February 2020, A214-p.A223
Non Patent Literature 5: “Jisha purodakuto ni howaitobokkusu-gata-ko denso sochi o mochiita bakkubon'nettowaku o kochiku—Tei kosuto de nettowaku no antei-sei to takai kasutamaizu-sei no ryoritsu ga kano ni (in Japanese) (Construction of backbone network using white box type optical transmission device in own product—achievement of both network stability and high customizability at low cost—)”, MIXI, Nov. 14, 2019, [online], retrieved on Jun. 28, 2022, <URL: https://mixi.co.jp/news/2019/1114/2096/>
Non Patent Literature 6: H. Nishizawa, five others, “Study on Open All-Photonic Network in IOWN Global Forum”, NTT Technical Review, [online], retrieved on Jun. 28, 2022, <URL: https://www.ntt-review.jp/archive/ntttechnical.php?contents=ntr202205fa2.html>
Non Patent Literature 7: “Open All-Photonic Network Functional Architecture”, IOWN GLOBAL FORUM, [online], retrieved on Jun. 28, 2022, <URL: https://iowngf.org/technology/#Open-All-Photonic-Network>

### SUMMARY OF INVENTION

### Technical Problem

However, the technique in the related art has an issue that there is no method for automatically setting an optical path by effectively using limited resources (in particular, transmission quality measurement devices) in a case where a carrier terminates and accommodates a connection request from a user terminal to a carrier network.

The present invention has been made in view of the above circumstances, and an object of the present invention is to provide a technique capable of automatically setting an optical path using limited resources.

### Solution to Problem

According to an aspect of the present invention, there is provided an optical transmission system including: a connection device that connects one or more user terminals to an optical transmission network for a carrier; and a control device that controls the connection device, in which the connection device includes a fixed number of measurement devices that measure a quality of a transmission line between the one or more user terminals and the connection device, a notification device that notifies the one or more user terminals of busy information, and a switching device that switches a connection destination of the one or more user terminals to any one of: one of the fixed number of measurement devices; the notification device; and the optical transmission network, the control device includes a control unit that controls the switching device, and the control unit detects a connection request from the one or more user terminals, and in a case where a measurement device of the fixed number of measurement devices is available, connects the user terminal to the measurement device available, in a case where none of the fixed number of measurement devices is available, temporarily connects the user terminal to the notification device, and when a measurement device of the fixed number of measurement devices has become available, connects the user terminal to the measurement device available, and after the quality of the transmission line is measured by the measurement device connected, connects the user terminal to the optical transmission network.

According to an aspect of the present invention, there is provided an optical path setting/congestion control method performed by a connection device that connects one or more user terminals to an optical transmission network for a carrier and a control device that controls the connection device, in which the connection device includes a fixed number of measurement devices that measure a quality of a transmission line between the one or more user terminals and the connection device, a notification device that notifies the one or more user terminals of busy information, and a switching device that switches a connection destination of the one or more user terminals to any one of: one of the fixed number of measurement devices; the notification device; and the optical transmission network, the control device includes a control unit that controls the switching device, and the method causing the control unit to execute: detecting a connection request from the one or more user terminals, and in a case where a measurement device of the fixed number of measurement devices is available, connecting the user terminal to the measurement device available, in a case where none of the fixed number of measurement devices is available, temporarily connecting the user terminal to the notification device, and when a measurement device of the fixed number of measurement devices has become available, connecting the user terminal to the measurement device available, and after the quality of the transmission line is measured by the measurement device connected, connecting the user terminal to the optical transmission network.

### Advantageous Effects of Invention

According to the present invention, it is possible to provide a technique capable of automatically setting an optical path using limited resources.

### BRIEF DESCRIPTION OF DRAWINGS

FIG. 1 is a diagram illustrating a configuration of an optical transmission system.

FIG. 2 is a diagram illustrating an example of a network architecture.

FIG. 3 is a diagram illustrating an example of a network architecture.

FIG. 4 is a diagram illustrating an example of a network architecture.

FIG. 5 is a diagram illustrating an example of a network architecture.

FIG. 6 is a diagram illustrating an example of a network architecture.

FIG. 7 is a diagram illustrating a control sequence of the optical transmission system.

FIG. 8 is a diagram illustrating a processing image of the optical transmission system.

FIG. 9 is a diagram illustrating a processing image of the optical transmission system.

FIG. 10 is a diagram illustrating a processing image of the optical transmission system.

FIG. 11 is a diagram illustrating a processing image of the optical transmission system.

FIG. 12 is a diagram illustrating a processing image of the optical transmission system.

FIG. 13 is a diagram illustrating a processing image of the optical transmission system.

FIG. 14 is a diagram illustrating a processing image of the optical transmission system.

FIG. 15 is a diagram illustrating a processing image of the optical transmission system.

FIG. 16 is a diagram illustrating a first congestion control method.

FIG. 17 is a diagram illustrating the first congestion control method.

FIG. 18 is a diagram illustrating the first congestion control method.

FIG. 19 is a diagram illustrating a second congestion control method.

FIG. 20 is a diagram illustrating a third congestion control method.

FIG. 21 is a diagram illustrating a fourth congestion control method.

FIG. 22 is a diagram illustrating an example of transmission line information.

FIG. 23 is a diagram illustrating the fourth congestion control method.

FIG. 24 is a diagram illustrating a fifth congestion control method.

FIG. 25 is a diagram illustrating an example of transmission line information.

FIG. 26 is a diagram illustrating the fifth congestion control method.

FIG. 27 is a diagram illustrating a processing image of a specific example.

FIG. 28 is a diagram illustrating a processing image of a specific example.

FIG. 29 is a diagram illustrating a processing image of a specific example.

FIG. 30 is a diagram illustrating a processing image of a specific example.

FIG. 31 is a diagram illustrating a processing image of a specific example.

FIG. 32 is a diagram illustrating a processing image of a specific example.

FIG. 33 is a diagram illustrating a hardware configuration of a control device.

### DESCRIPTION OF EMBODIMENTS

Hereinafter, an embodiment of the present invention will be described with reference to the drawings. In the drawings, the same parts are denoted by the same reference numerals, and description thereof is omitted.

### Summary of Invention

The present invention is an invention related to a technique of automatically setting an optimum optical path based on a connection request from one or more user terminals connected to an optical transmission network (hereinafter, a carrier network) of a carrier via a transmission line of a dark fiber.

When setting and establishing an optical path, the quality of a transmission line between a user terminal and a connection device is measured, an optimum transmission mode is determined based on the transmission quality, and processing for λ-connection to the carrier network in the transmission mode is performed. Here, the transmission quality measurement device is very expensive, and in a case where the measurement device is frequently used, enormous costs are incurred. Meanwhile, it is desired to accommodate connection requests from a plurality of user terminals without blocking (without waiting) as far as possible while preparing a small number of measurement devices.

Therefore, the present invention discloses a connection device that connects a user terminal to a carrier network and a control device that controls the connection device. The connection device includes an optical path switching device, a small number of measurement devices, and a notification device that performs notification of Busy information. In a case where none of the measurement devices is available, the control device performs congestion control for connection requests based on a priority, urgency, or the like of the connection requests, temporarily connects the user terminal to the notification device to notify a user of Busy information, and when a measurement device has become available, connects the connection request to the available measurement device.

Thereby, even in a case where there is an upper limit to the number of measurement devices, it is possible to automatically set many optical paths for a plurality of connection requests from one or more user terminals. In addition, in a case where there is congestion with respect to connection requests, it is possible to automatically set an appropriate optical path in consideration of priority, urgency, or the like.

### System Configuration

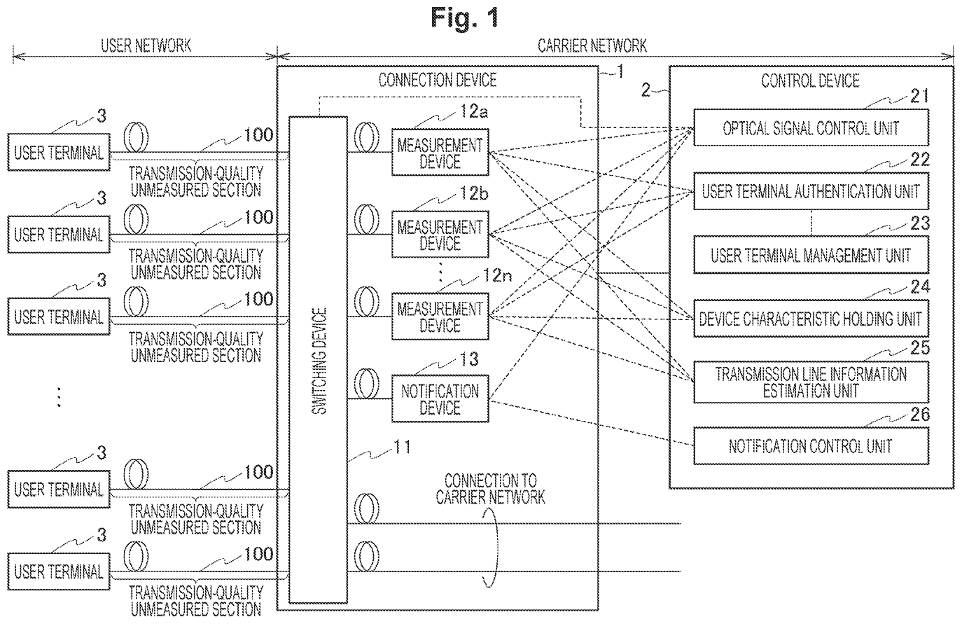

FIG. 1 is a diagram illustrating a configuration of an optical transmission system according to the present embodiment. The optical transmission system includes a connection device 1 that connects a user terminal 3 to a carrier network, and a control device 2 that controls the connection device 1. The optical transmission system may be implemented as one device (a connection node) or may be implemented in combination with a device of a vendor.

User terminals 3 are one or more user base terminals existing outside the carrier network. The user terminals 3 are connected to the connection device 1 via respective transmission lines 100, and each of the user terminals 3 includes a transmission/reception unit that transmits and receives optical signals to and from the connection device 1 via the corresponding transmission line 100. Each user terminal 3 is, for example, a communication device, e.g. in a data center, and is specifically a transceiver or the like.

The connection device 1 includes a switching device 11, a measurement device 12, and a notification device 13. The switching device 11 switches a connection destination of the user terminal 3 to any one of the measurement device 12, the notification device 13, and the carrier network. The measurement device 12 measures the quality of the transmission line 100 between the user terminal 3 and the connection device. The notification device 13 notifies the user terminal 3 of Busy information or the like. The connection device 1 is disposed, for example, in the carrier network.

The switching device 11 is a device that terminates an optical signal from the user terminal 3 and connects the user terminal 3 to the measurement device 12 and the notification device 13 in order to measure the quality of a transmission section and perform terminal authentication. In addition, the switching device 11 is a device that, after performing these pieces of processing, in a case where connection to the carrier network is possible, connects a user terminal 3 to the carrier network and blocks an optical signal from an abnormal terminal or a user terminal 3 for which connection is not permitted. The switching device 11 is, for example, an optical switch.

There are a fixed number of measurement devices 12, each of which measures the quality of a transmission line 100 which is a transmission-quality unmeasured section. The fixed number is a small number equal to or larger than 1 considering that the measurement device 12 is expensive. The measurement device 12 is, for example, a coherent transceiver.

There are one or more notification devices 13, each of which notifies the user terminal of information indicating Busy/OK/Interruption/connection denial (Denied) by using a predefined signal that can be distinguished/identified/determined by a user. For example, the notification device 13 generates Busy information or the like on a main signal, and performs notification of the Busy information or the like, without preparing another wavelength such as in AMCC or OTN-GCC. In addition, the notification device 13 transmits the Busy information or the like using a signal in a specific wavelength band, such as in OSC.

The control device 2 includes an optical signal control unit 21 that controls an optical signal, a user terminal authentication unit 22 that authenticates the user terminal 3, a user terminal management unit 23 that manages information of the user terminal 3, a device characteristic holding unit 24 that holds a device characteristic of the measurement device 12, a transmission line information estimation unit 25 that measures the quality of the transmission line 100 between the user terminal 3 and the connection device, and a notification control unit 26 that notifies the user terminal 3 of Busy information or the like. The control device 2 is disposed, for example, in a server device in the carrier network.

The optical signal control unit 21 has a function of controlling and monitoring the switching device 11, a function of collecting information from the measurement device 12 and monitoring the measurement device 12, and a function of controlling the notification device 13. Specifically, the optical signal control unit 21 detects a connection request from the user terminal 3, and in a case where a measurement device of the fixed number of measurement devices 12 is available, connects the user terminal 3 to the available measurement device 12. In a case where none of the fixed number of measurement devices 12 is available, the optical signal control unit 21 temporarily connects the user terminal 3 to the notification device 13, and in a case where a measurement device 12 has become available, connects the user terminal 3 to the available measurement device 12. After the quality of the transmission line is measured by the connected measurement device 12, the optical signal control unit 21 connects the user terminal 3 to the carrier network.

The user terminal authentication unit 22 has a function of authenticating the user terminal 3 connected from the outside of the carrier network by referring to information of the user terminal 3 that is held in the user terminal management unit 23, and determining whether or not connection to the carrier network is possible.

The user terminal management unit 23 has a function of holding user terminal information of the user terminal 3 connected from the outside of the carrier network. The user terminal information includes, for example, a user name, a registration number assigned by a carrier, a line ID, a terminal ID/model number/serial number/MAC address of the user terminal, and a port number of the switching device 11 to which the user terminal is connected.

The device characteristic holding unit 24 has a function of holding an actual device characteristic of each of the fixed number of measurement devices 12. The actual device characteristic is data required for estimating the quality of a transmission section from a value of a BER. For example, the actual device characteristic is data representing a relationship between a BER and an OSNR.

The transmission line information estimation unit 25 has an estimation function of estimating and calculating transmission quality of a transmission section between the user terminal 3 and the carrier network, and a holding function of holding the estimated transmission quality information, a timing when the transmission quality is last measured, and the like. Note that the estimation function and the holding function may be implemented by separate functional units.

The notification control unit 26 has a function of controlling and managing the notification device 13. The notification control unit 26 may be disposed inside the optical signal control unit 21.

### Network Architecture

As a connection form on the user terminal side, there are a form in which one user terminal is connected to one transmission line, a form in which one or more user terminals are connected to one transmission line and a multiplexer is connected, and a form in which these two forms are mixed.

In contrast, as a connection form at the entrance on the carrier side, there are a form in which a demultiplexer is connected, and a form in which a demultiplexer is not connected. Types of the switching device 11 include an FXC and a WXC (wavelength switches including WSS/ROADM).

It is considered to obtain a network architecture by combining these forms. For example, in a case where the connection form on the user terminal side is one user terminal on one transmission line, the connection form at the entrance on the carrier side may be either a form in which a demultiplexer is connected, or a form in which a demultiplexer is not connected, and the switching device 11 may be either an FXC or a WXC.

In addition, it is also considered to obtain a network architecture. For example, in a case where the connection form on the user terminal side is one or more user terminals and a multiplexer on one transmission line, and where the connection form at the entrance on the carrier side does not connect a demultiplexer, the switching device 11 may be a WXC.

In addition, it is also considered to obtain a network architecture. For example, in a case where the connection form on the user terminal side is one or more user terminals and a multiplexer on one transmission line, and where the connection form at the entrance on the carrier side connects a demultiplexer, the switching device 11 may be either an FXC or a WXC.

Of course, it is also considered to obtain a network architecture by a combination other than the above-described combinations.

A typical example of a network architecture is illustrated.

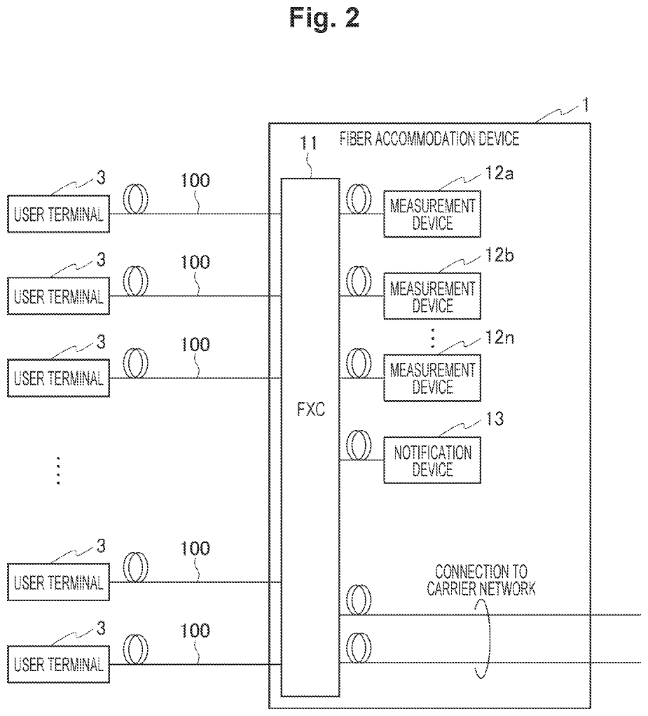

FIG. 2 is a network architecture in which one user terminal 3 is connected to one transmission line 100 and an FXC is used as the switching device 11.

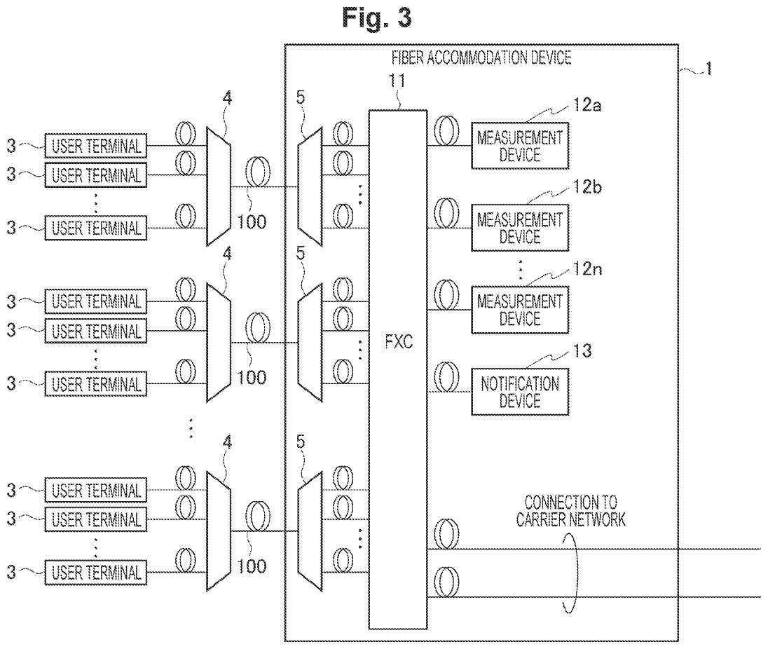

FIG. 3 is a network architecture in which one or more user terminals 3 are connected to one transmission line 100, a multiplexer 4 is disposed on the user terminal side, a demultiplexer 5 is disposed at the entrance on the carrier side, and an FXC is used as the switching device 11.

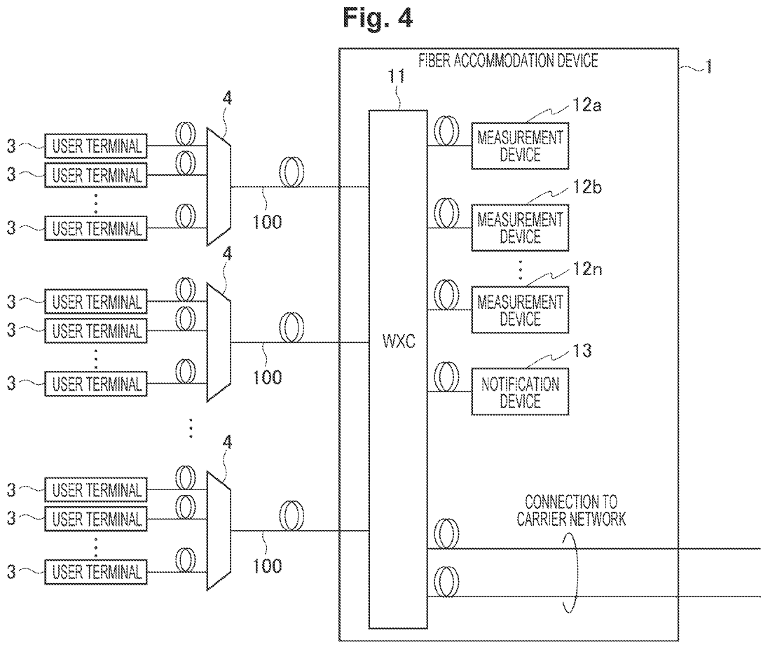

FIG. 4 is a network architecture in which one or more user terminals are connected to one transmission line 100, a multiplexer 4 is disposed on the user terminal side, and a WXC is used as the switching device 11.

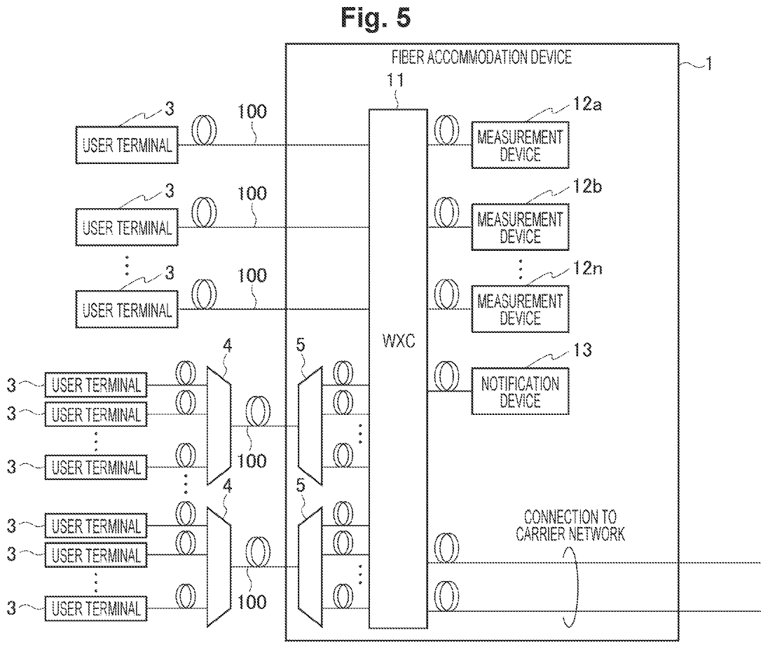

FIG. 5 is a network architecture in which only one or one or more user terminals are connected to one transmission line 100, a multiplexer 4 is disposed on the user terminal side on which one or more user terminals are connected, a demultiplexer 5 is disposed at the entrance on the carrier side corresponding to the user terminal side on which the multiplexer 4 is disposed, and a WXC is used as the switching device 11.

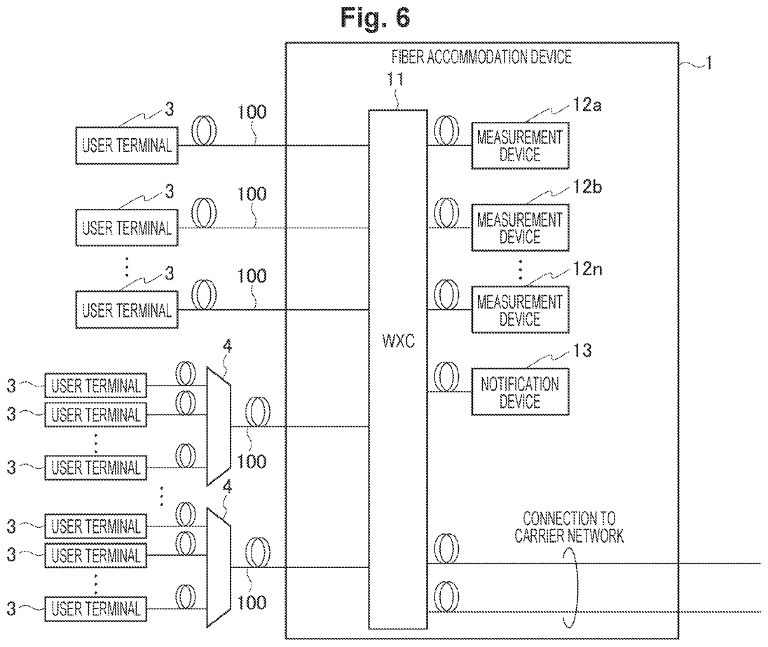

FIG. 6 is a network architecture in which only one or one or more user terminals are connected to one transmission line 100, a multiplexer 4 is disposed on the user terminal side on which one or more user terminals are connected, and a WXC is used as the switching device 11.

Note that the multiplexer 4 and the demultiplexer 5 are, for example, wavelength multiplexing/demultiplexing devices.

### Overall Operation of System

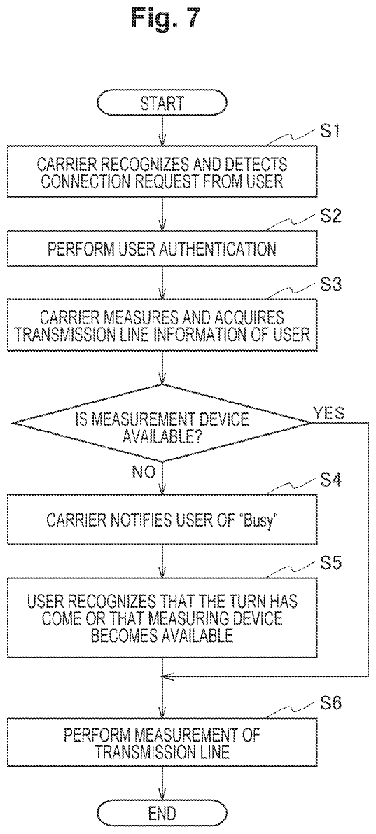

FIG. 7 is a diagram illustrating a control sequence of the optical transmission system.

### Step S1

First, the carrier recognizes and detects a connection request from a user. Specifically, the optical signal control unit 21 monitors an optical signal indicating arrival of a connection request. In addition, the user notifies the carrier that a connection request is transmitted by using an API or the like dedicated to communication with the carrier.

At this time, in a case where the user performs an operation different from the assumption of the carrier, the optical signal control unit 21 blocks the optical signal from the user by using a function of connecting to a Parking-State (a default position provided in advance for unexpected operation), or an optical signal disconnection function, of the switching device 11. The notification device 13 may notify the user of a connection not permitted/connection stop command.

### Step S2

Next, authentication of the user is performed. Specifically, the user terminal authentication unit 22 authenticates the user terminal 3 from which the connection request is transmitted, based on a terminal ID and a line ID. The user terminal authentication unit 22 may perform one or more types of authentication (two-stage authentication or the like) in one or more layers.

At this time, in a case where the user performs an operation different from the assumption of the carrier, the optical signal control unit 21 blocks the optical signal from the user by using a function of connecting to a Parking-State, or an optical signal disconnection function, of the switching device 11. The notification device 13 may notify the user of a connection not permitted/connection stop command.

### Step S3

Next, the carrier measures and acquires transmission line information of the user. Specifically, the transmission line information estimation unit 25 measures the quality of the transmission line 100 between the connection device and the user terminal 3 from which the connection request is transmitted.

At this time, in a case where an elapsed time from the previous measurement timing is equal to or shorter than a threshold value and there is no information on construction or the like, related to the transmission line, the transmission line information estimation unit 25 may reuse a past measurement result without performing quality measurement of the transmission line. Further, the transmission line information estimation unit 25 may reuse a past measurement result in a case where a connection request is received from the user terminal 3 on which connection is performed in the past.

Thereafter, in a case where the past measurement result is not reused or cannot be reused, the transmission line information estimation unit 25 checks whether or not a measurement device 12 is available. In a case where a measurement device 12 is available, the process proceeds to step S6, and in a case where the measurement devices 12 are not available, the process proceeds to step S4.

### Step S4

In a case where the measurement devices 12 are not available, the carrier notifies the user of Busy information. Specifically, the notification control unit 26 transmits the Busy information from the notification device 13 to the user terminal 3. At this time, the carrier may interrupt quality measurement of a user having a low priority among the users in quality measurement of transmission lines, notify the user of interruption information, and forcibly make a measurement device 12 in quality measurement of a transmission line available.

### Step S5

After step S4, the user recognizes that the turn has come and that a measurement device 12 is available. For example, the notification control unit 26 and the notification device 13 transmit an OK signal to the user terminal 3.

Note that the user may periodically attempt reconnection until an OK signal is received. As a periodic connection method, there are a method of performing connection at predetermined time intervals and a method of performing reconnection using a setting (for example, an exponential back-off) of an existing retransmission timer.

In addition, the notification device 13 may notify the user of a retry timing using a Busy signal, and the user may attempt to perform reconnection at the retry timing. The optical signal control unit 21 may schedule a connection timing and allocation of a measurement device 12 for each user terminal 3 by using the ID of the user terminal 3. The user terminal 3 may put information indicating that the priority is high on the optical signal of the connection request, and instruct to cause a measurement device 12 to be available such that the connection can be preferentially performed. The carrier may dynamically change the priority of a user terminal 3 according to the operation or the like of the user terminal 3, and preferentially perform connection of a user terminal 3 having a higher priority.

### Step S6

After step S5 or in a case where there is an available measurement device 12, measurement of the transmission line is performed. Specifically, the transmission line information estimation unit 25 measures the quality of the transmission line 100 between the connection device and the user terminal 3 from which the connection request is transmitted. The transmission line information estimation unit 25 may record the measurement result together with a measurement completion timing.

Thereafter, the control device 2 determines an optimum transmission mode based on the measured transmission quality, notifies the user of the transmission mode, and λ-connects the user terminal to the carrier network in the transmission mode. Note that existing methods are used as a transmission mode determination method and a notification method.

### Step S7 (Not Illustrated in FIG. 7)

In step S1 to step S6, a connection request in a normal state is assumed. On the other hand, there is a case where a connection request in an emergency state is received. In a case of occurrence of such emergency communication, the control device 2 notifies a user in quality measurement of a transmission line, of Interruption/Busy information, interrupts the quality measurement of the transmission line, and prioritizes the quality measurement of a transmission line related to the emergency connection request. Thereafter, the control device 2 processes the interrupted quality measurement as usual using an available measurement device.

The entire operation of the optical transmission system has been described above. Note that step S2 to step S4 may be performed in any order. For example, user authentication may be performed after the availability of a measurement device 12 is determined, and quality measurement of the transmission line may be performed in a case where there is an available measurement device 12 and user authentication is OK.

### Specific Processing of Step S1 to Step S7

### Specific Processing in Step S1

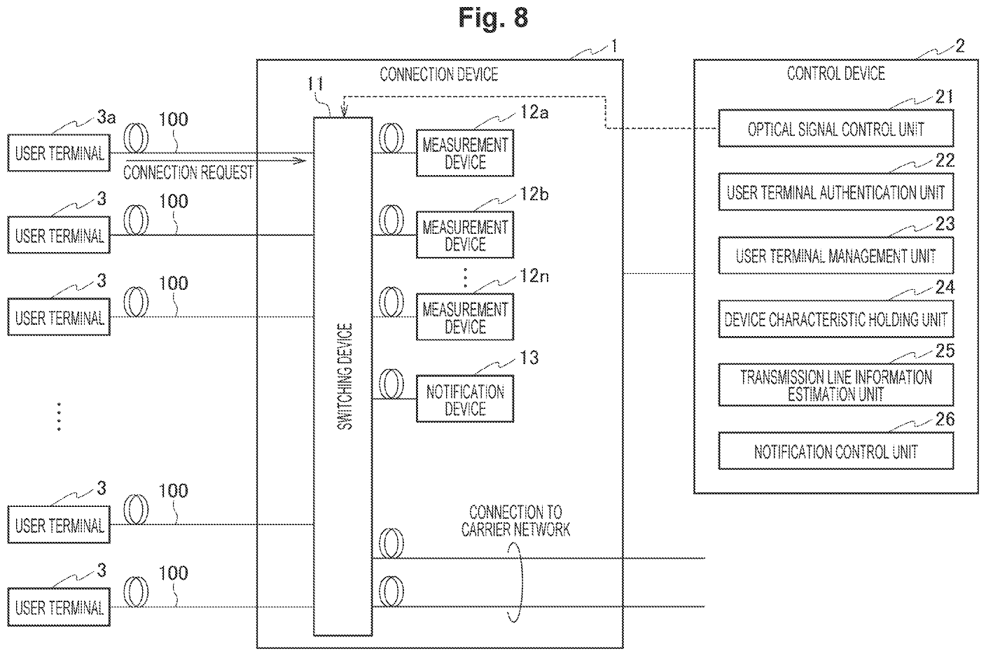

A user terminal 3a puts a connection request and terminal information on an optical signal, and transmits the optical signal to the carrier side (refer to FIG. 8). At this time, the user may explicitly notify the carrier that the connection request is transmitted. The user terminal 3 may include, in the connection request, a priority of the connection request (emergency connection or the like) and a purpose of the connection (periodic data backup or the like).

The optical signal control unit 21 monitors and detects an optical signal level from the user terminal 3a. In a case where the carrier is notified that the user transmits a connection request, the optical signal control unit 21 receives the notification content.

### Specific Processing in Step S2

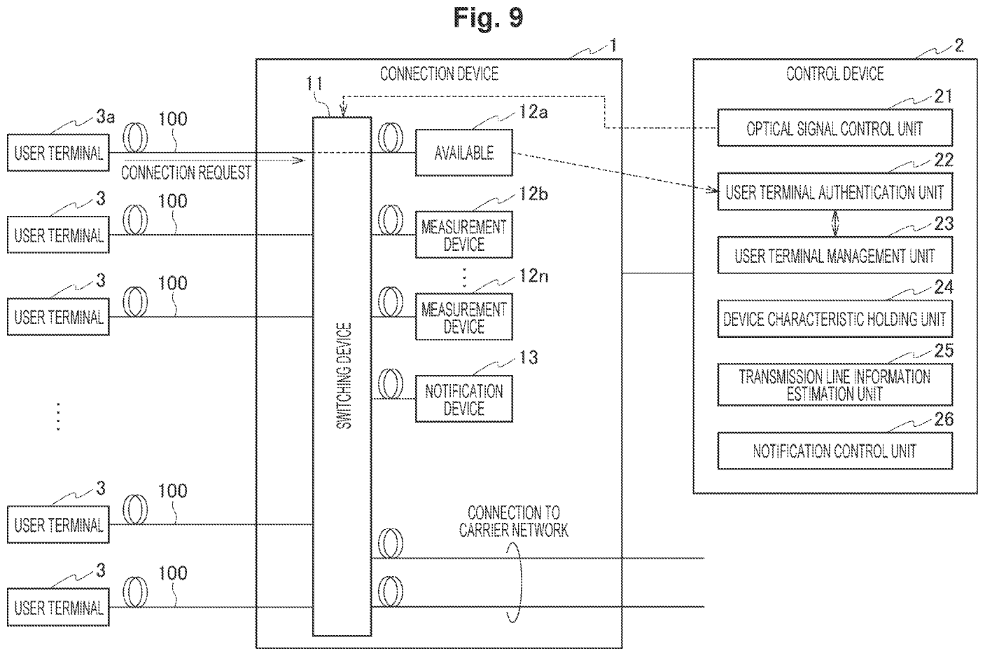

The optical signal control unit 21 checks the availability of measurement devices 12a to 12n, and in a case where any one of the measurement devices 12a to 12n is available, connects the user terminal 3a to the available measurement device 12a (refer to FIG. 9). In a case where none of the measurement devices 12a to 12n is available, congestion control to be described later is performed.

The user terminal authentication unit 22 extracts terminal information included in the optical signal received by the measurement device 12a, and acquires information of the connected user terminal 3a. Thereafter, the user terminal authentication unit 22 refers to the user terminal management unit 23, and performs collation with the acquired information of the user terminal 3a.

### Specific Processing in Step S3

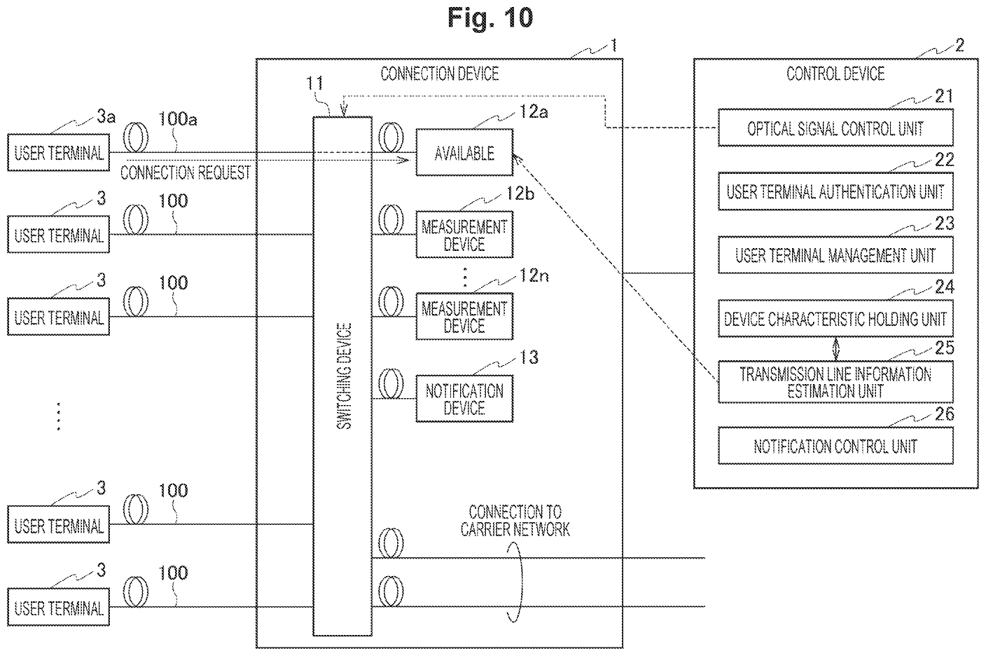

The transmission line information estimation unit 25 acquires the actual device characteristic (data representing a relationship between a BER and an OSNR) of the measurement device 12a to which the connection request has arrived, from the device characteristic holding unit 24, and estimates transmission quality of a transmission line 100a, which is a transmission-quality unmeasured section, using the actual device characteristic of the measurement device 12a (refer to FIG. 10).

At this time, the transmission line information estimation unit 25 may estimate transmission line information (a level diagram, a loss, and a fiber type) by using “Takeo Sasai, five others, ‘Digital Backpropagation for Optical Path Monitoring: Loss Profile and Passband Narrowing Estimation’, 2020 European Conference on Optical Communications (ECOC), 2020”, and estimate the transmission quality based on the transmission line information.

Further, as described above, in a case where an elapsed time from the previous measurement timing is equal to or shorter than a threshold value and there is no information on construction or the like, related to the transmission line, the transmission line information estimation unit 25 may reuse a past measurement result without performing quality measurement of the transmission line. Further, the transmission line information estimation unit 25 may reuse a past measurement result in a case where a connection request is received from a user terminal 3 on which connection is performed in the past.

### Specific Processing in Step S4

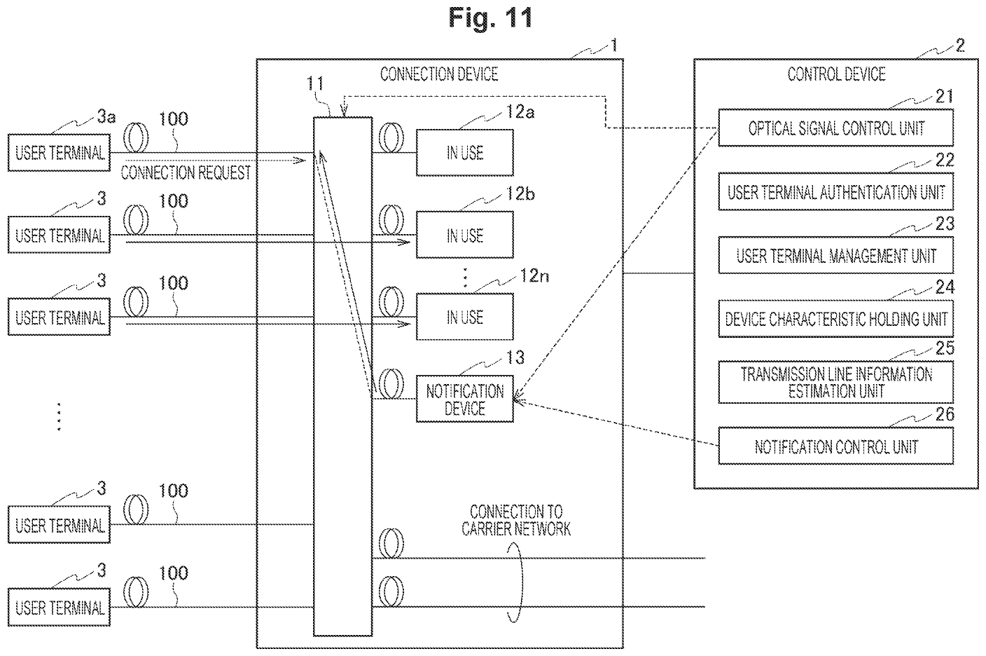

In a case where none of the measurement devices 12a to 12n is available, the optical signal control unit 21 connects the user terminal 3a to the notification device 13 (refer to FIG. 11). Thereafter, the notification control unit 26 and the notification device 13 notify the user terminal 3a of Busy information.

At this time, as described above, the optical signal control unit 21 may interrupt quality measurement of a user having a low priority among the users in quality measurement of transmission lines, notify the user of interruption information, and forcibly make a measurement device 12 in quality measurement of a transmission line available. The priority of a user is determined based on, for example, information registered in the user terminal management unit 23 and a priority explicitly designated by the user when the connection is requested.

### Specific Processing in Step S5

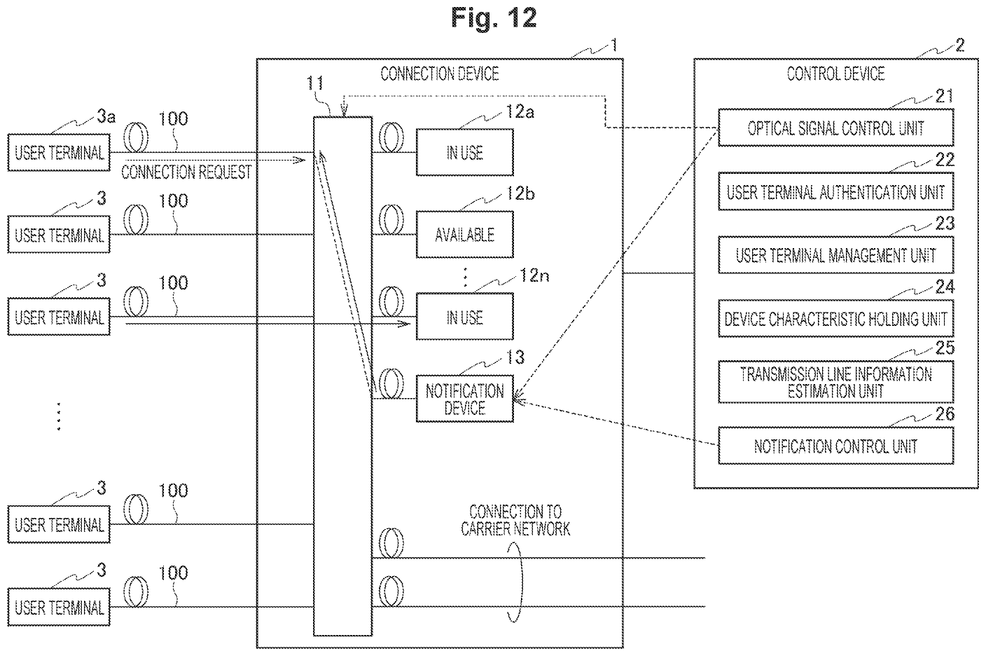

After a measurement device 12 becomes available, the optical signal control unit 21 connects the notification device 13 to the user terminal 3 (user terminal 3a) for which user authentication and transmission quality estimation are not completed (refer to FIG. 12). Thereafter, the notification control unit 26 and the notification device 13 transmit an OK signal to the user terminal 3a, which is a connection destination.

At this time, the notification device 13 may notify the user of a message for urging the user to periodically attempt reconnection until any one of the measurement devices 12a to 12n becomes available. In addition, the user himself/herself may periodically attempt reconnection. In addition, the notification device 13 may estimate a timing at which any one of the measurement devices 12a to 12n becomes available, notify the user of the estimated timing as a retry timing, and perform control such that the user attempts reconnection at the retry timing.

Further, the optical signal control unit 21 may schedule a connection timing and allocation of a measurement device 12 for each user terminal by using the information of the user terminal 3. The user terminal 3 may put information indicating that the priority is high on the connection request signal, and instruct to cause a measurement device to be available such that the connection can be preferentially performed. The carrier may dynamically change the priority of a user terminal 3 according to the operation or the like of the user terminal 3, and preferentially perform connection of a user terminal 3 having a higher priority.

### Specific Processing in Step S6

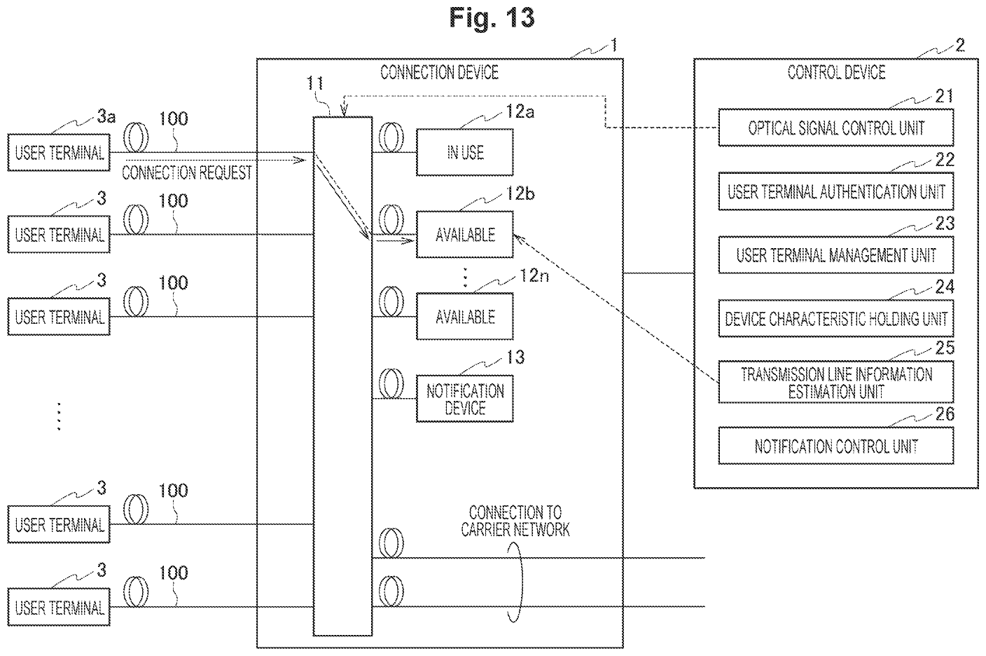

After any one of the measurement devices 12a to 12n becomes available, the optical signal control unit 21 connects the user terminal 3 (the user terminal 3a) for which user authentication and transmission quality estimation are not completed, to the measurement device 12b, which has become available, and notifies the transmission line information estimation unit 25 of information (for example, a location of the measurement device and a slot number) for connection to the available measurement device 12b (refer to FIG. 13).

The transmission line information estimation unit 25 is connected to the measurement device 12b, which is notified of the information from the optical signal control unit 21, and measures a transmission quality of the transmission line 100a, which is a transmission-quality unmeasured section. After transmission quality measurement is completed, the transmission line information estimation unit 25 may record the measurement result together with a measurement completion timing.

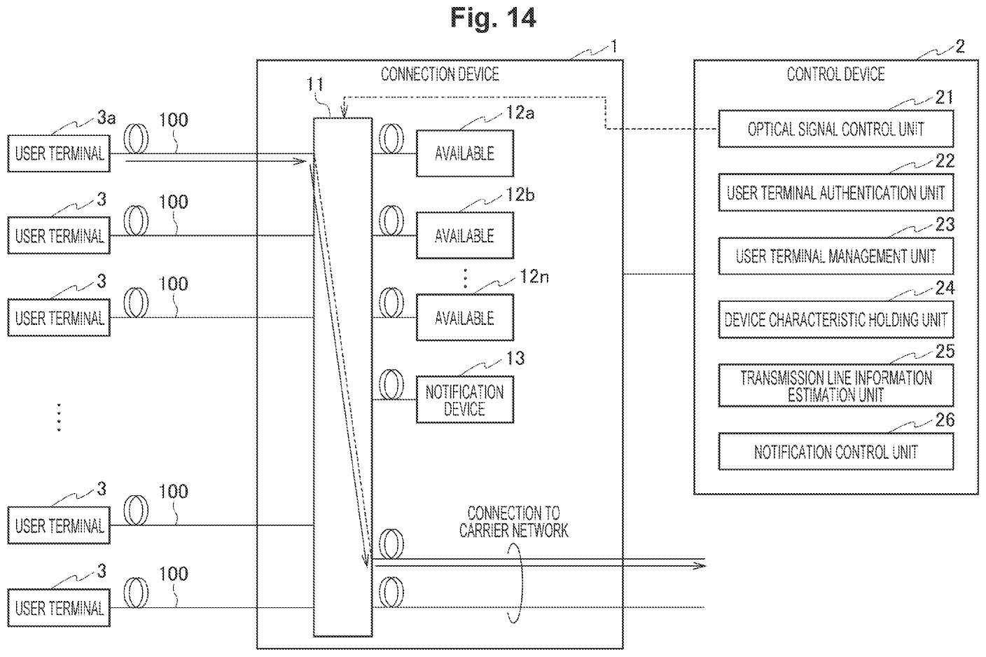

Thereafter, the optical signal control unit 21 establishes a route of the optical path related to the connection request of the user terminal 3a in the carrier network, then controls the switching device 11, and connects the user terminal 3a to the carrier network (refer to FIG. 14).

### Specific Processing in Step S7

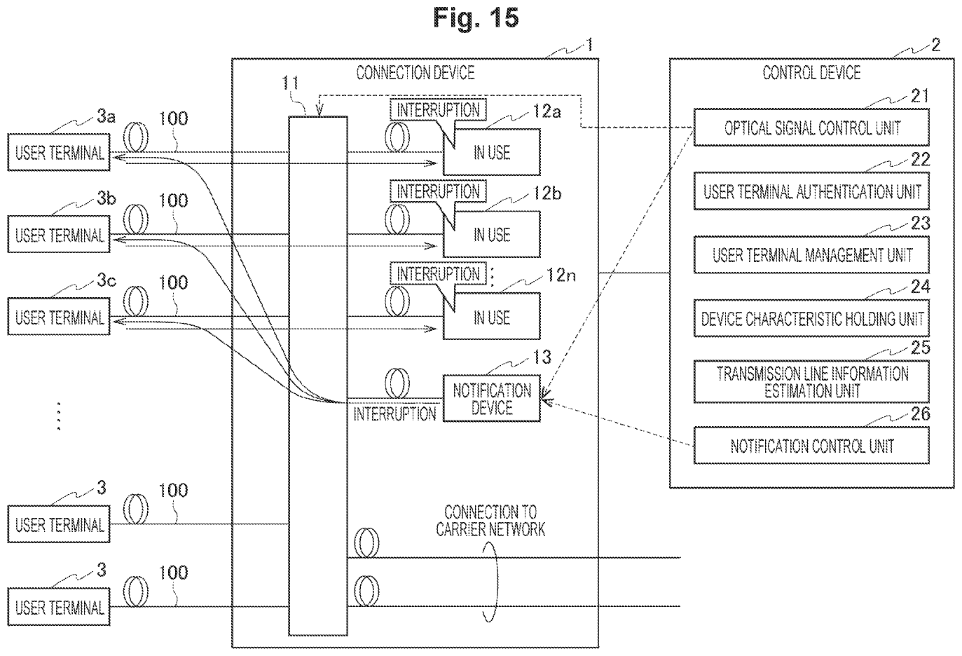

In a case of occurrence of emergency communication, the optical signal control unit 21 notifies the user terminals 3a to 3c in quality measurement of transmission lines, of Interruption/Busy information, interrupts the quality measurement of the transmission lines, and gives a priority to quality measurement of a transmission line related to the emergency connection request (refer to FIG. 15).

### Congestion Control

Congestion control will be described. In five types of congestion control to be described later, each type of congestion control may be performed individually, or two or more types of congestion control among the five types of congestion control may be performed in combination.

### First Congestion Control Method

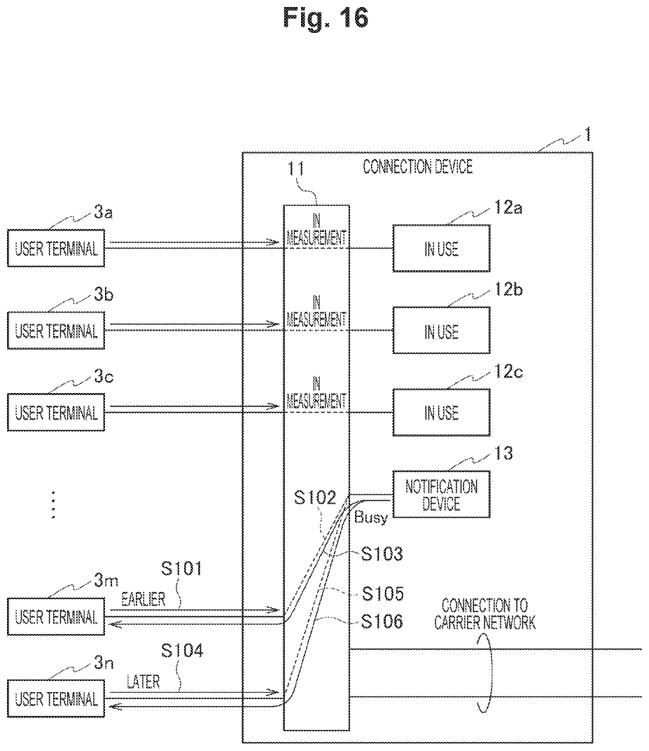

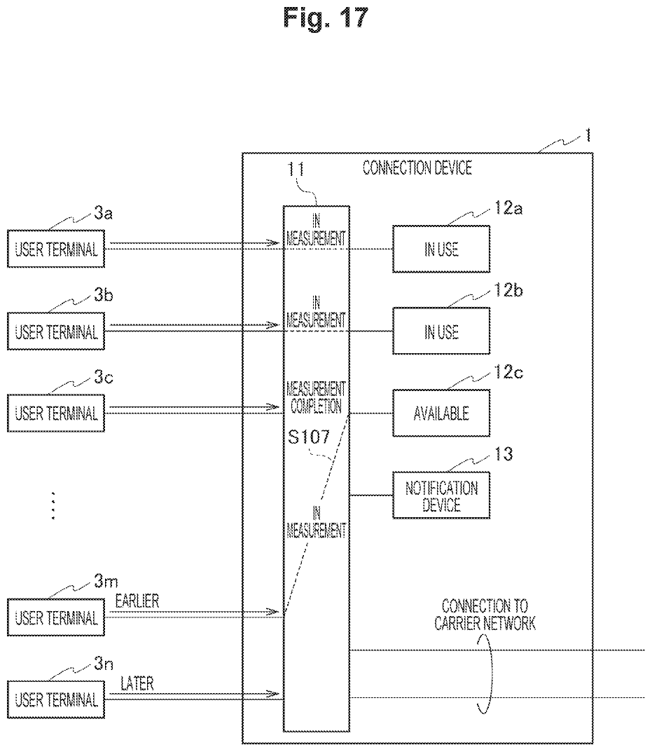

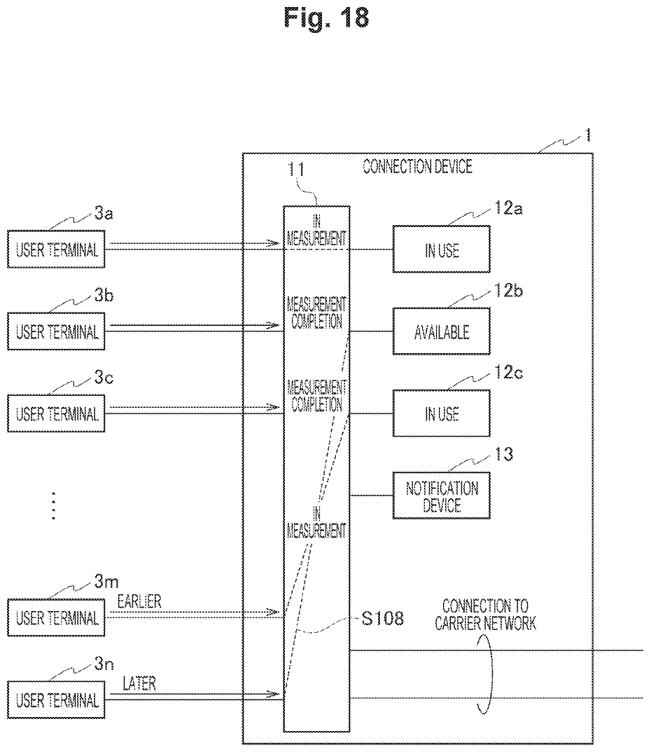

The first congestion control method is a FIFO method that processes connection requests in order of arrival (refer to FIG. 16 to FIG. 18). Specifically, in the method, in a case where the fixed number of measurement devices 12 are not available, when there are a plurality of connection requests, a user terminal 3 is connected to a measurement device 12 that has become available, in order of arrival of the connection requests.

It is assumed that the connection device 1 includes three measurement devices 12a to 12c. The three measurement devices 12a to 12c are line-synchronized with the user terminals 3a to 3c, respectively, and it takes several minutes to complete estimation of the transmission quality from the BER.

In a case where all the three measurement devices 12a to 12c are in use, when a connection request signal from a user terminal 3m is received (step S101), the optical signal control unit 21 connects the user terminal 3m to the notification device 13 in order to notify the user terminal of Busy (step S102).

Thereafter, the notification control unit 26 and the notification device 13 notify the user terminal 3m of Busy information (step S103). For example, an AMCC/GCC/pilot tone indicating Busy, a signal OSC having a specific wavelength indicating Busy, or the like is transmitted.

Next, in a case where a connection request signal from a user terminal 3n is received (step S104), the optical signal control unit 21 connects the user terminal 3n to the notification device 13 to notify the user terminal of Busy (step S105). Thereafter, the notification control unit 26 and the notification device 13 notify the user terminal 3n of Busy information by the same method as described above (step S106).

The optical signal control unit 21 repeatedly switches the connection destination of the notification device 13 to the user terminal 3m or the user terminal 3n, and the notification control unit 26 and the notification device 13 periodically transmit a Busy signal to the user terminal 3m and the user terminal 3n until any one of the measurement devices 12a to 12c becomes available.

Thereafter, in a case where any one of the measurement devices 12a to 12c has become available, the optical signal control unit 21 connects the user terminal 3m to the measurement device 12c, which has become available (step S107), and then connects the user terminal 3n to the measurement device 12b, which has become available (step S108).

### Second Congestion Control Method

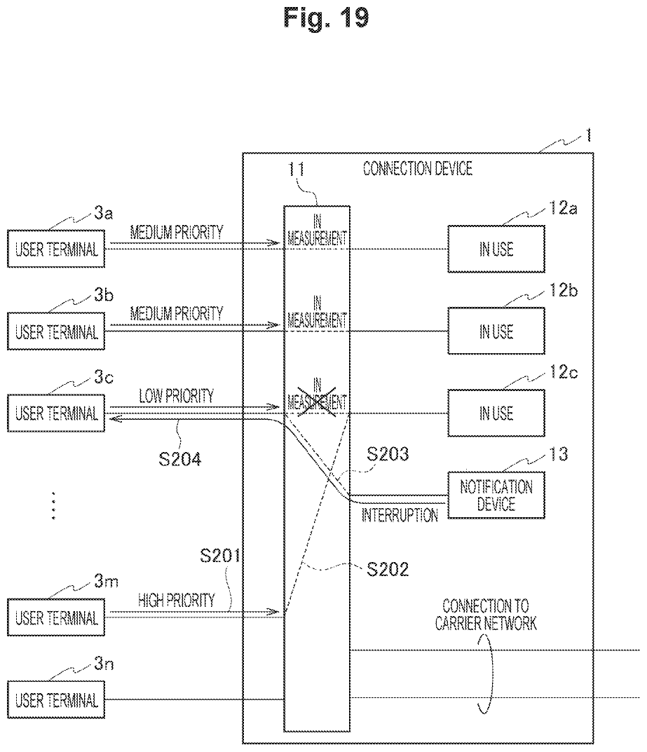

The second congestion control method is a preemptive method of processing connection requests in order of priority (refer to FIG. 19). Specifically, in the method, in a state where the fixed number of measurement devices 12 are not available, when there are a plurality of connection requests including a connection request in quality measurement of a transmission line, in a case where a priority of a new connection request is higher than the priority of the connection request in the quality measurement of the transmission line, the connection destination of the measurement device 12 in the quality measurement of the transmission line is switched to the user terminal of the new connection request.

In a case where all the three measurement devices 12a to 12c are in use, when a connection request signal having a high priority is received from the user terminal 3m (step S201), the optical signal control unit 21 switches the connection destination of the measurement device 12c in quality measurement for a connection request having a low priority, from the user terminal 3c to the user terminal 3m (step S202), and connects the user terminal 3c to the notification device 13 (step S203). Thereafter, the notification control unit 26 and the notification device 13 notify the user terminal 3c of interruption of transmission line estimation (step S204).

### Third Congestion Control Method

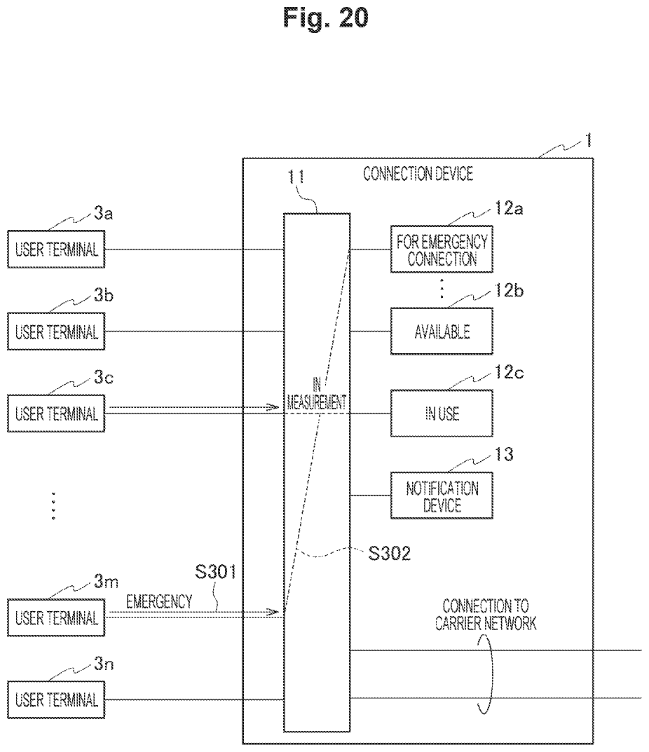

The third congestion control method is a control method of prioritizing an emergency connection request (refer to FIG. 20). Specifically, in the method, in a case where the connection request from the user terminal 3 is an urgent connection request, the user terminal 3 is connected to a measurement device that is used only in emergency among the fixed number of measurement devices 12.

One or more of the plurality of measurement devices 12 are prepared for emergency connection. The measurement device 12a for emergency connection is not used in a normal state, and is used only in an emergency state. In a case where an emergency connection request signal from the user terminal 3m is received (step S301), the optical signal control unit 21 connects the user terminal 3m to the measurement device 12a for emergency connection (step S302).

### Fourth Congestion Control Method

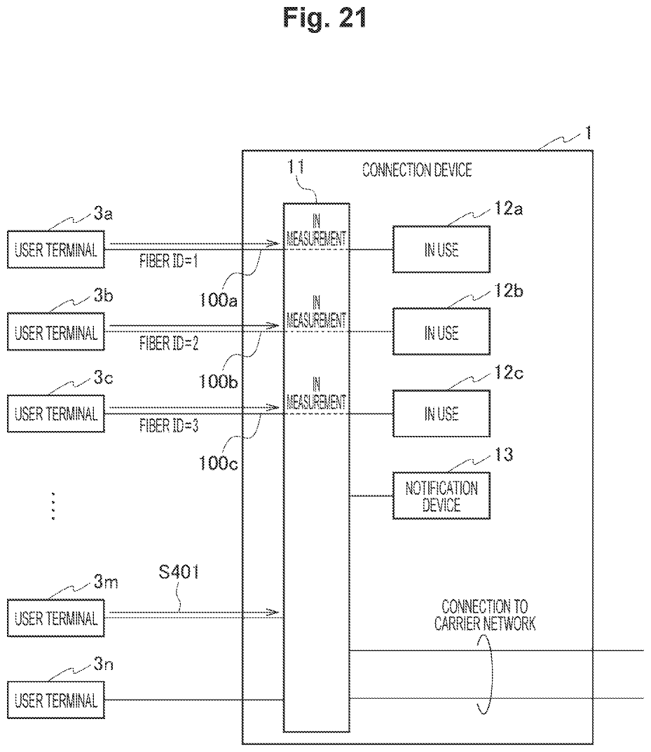

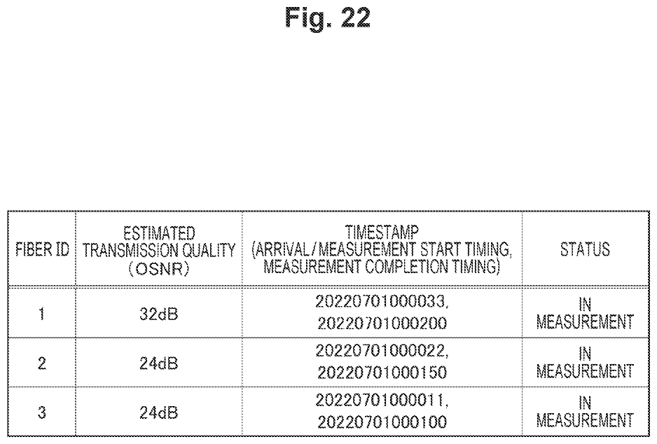

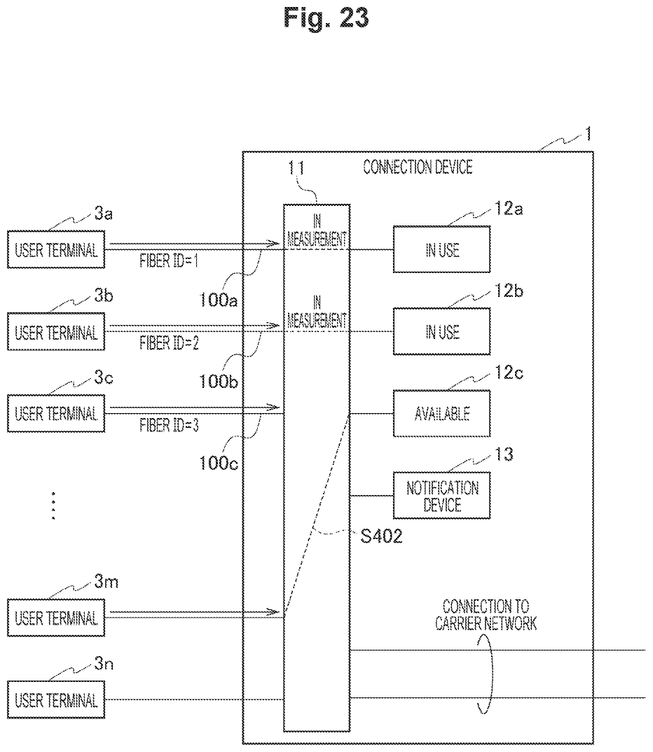

The fourth congestion control method is a control method in consideration of a final estimation timing of the transmission line quality (refer to FIG. 21 to FIG. 23). Specifically, in the method, in a case where the fixed number of the measurement devices 12 are not available, a user terminal 3 is connected to a measurement device 12 that has become available, in order of the earliest transmission line quality measurement completion timing in each measurement device.

It is assumed that all the three measurement devices 12a to 12c are in use and the transmission line information estimation unit 25 holds transmission line information such as measurement completion timings of the transmission lines 100a to 100c. In a case where a connection request signal is received from the user terminal 3m (step S401), the optical signal control unit 21 determines that there is almost no change in the transmission line information of the transmission section of the transmission line 100c for which the transmission line information is recently measured, and in order to hand over quality measurement processing to a connection request that has newly arrived from the user terminal 3m, connects the user terminal 3m to the measurement device 12c (step S402).

### Fifth Congestion Control Method

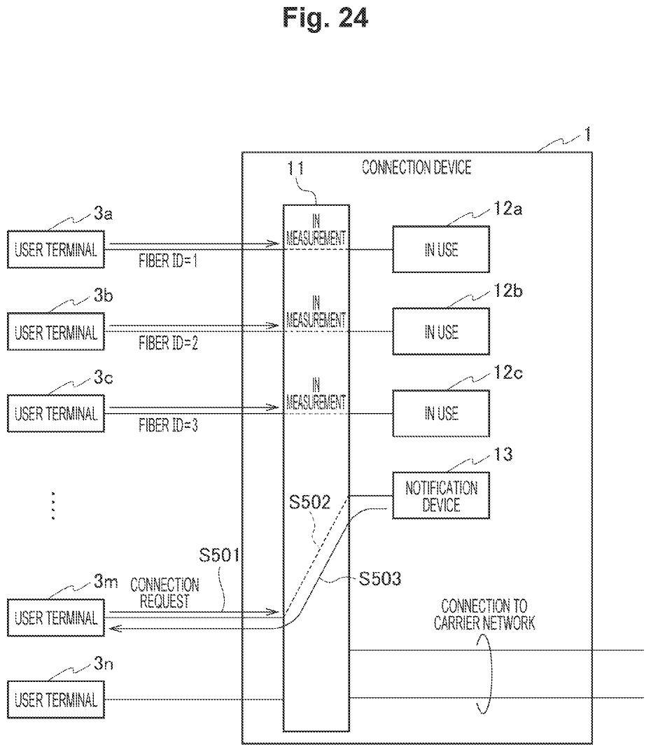

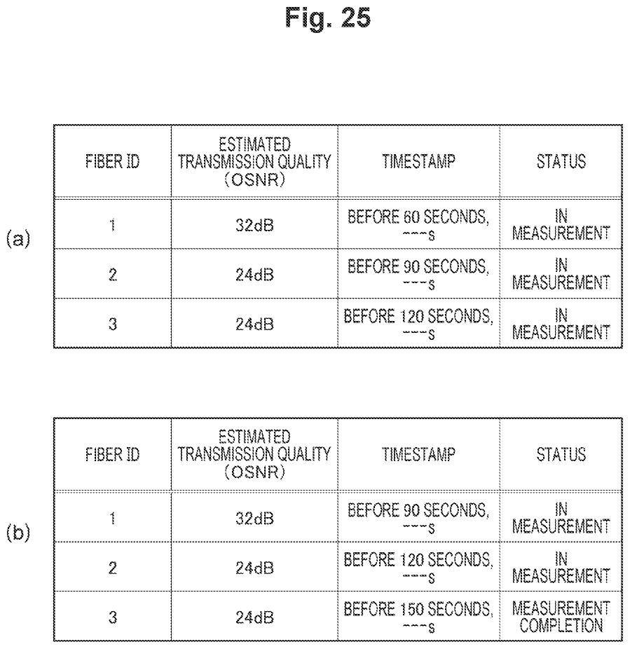

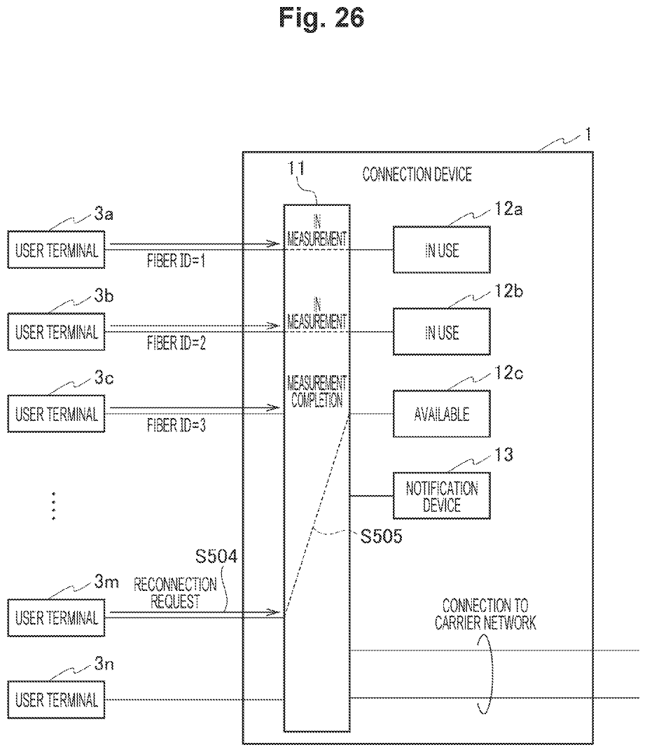

The fifth congestion control method is a timing-designation-type control method in consideration of the final estimation timing of the transmission line (refer to FIG. 24 to FIG. 26). Specifically, in the method, in a case where the fixed number of measurement devices 12 are not available, a user terminal 3 is connected to a measurement device 12 that has become available, in order of designated timings of reconnection requests.

It is assumed that all the three measurement devices 12a to 12c are in use and the transmission line information estimation unit 25 holds transmission line information on how many seconds ago the measurement of the transmission lines 100a to 100c has started, or the like. In a case where a connection request signal is received from the user terminal 3m (step S501), the optical signal control unit 21 connects the user terminal 3m to the notification device 13 to notify the user terminal of Busy (step S502).

Thereafter, the notification control unit 26 and the notification device 13 set, as a reconnection timing, a measurement completion timing of the measurement device 12c, which becomes available earliest among the measurement devices 12a to 12c, based on the transmission line information held in the transmission line information estimation unit 25, and notify the user terminal 3m of the reconnection timing (step S503). For example, reconnection is requested at a oo timing after 30 seconds.

Thereafter, the optical signal control unit 21 receives a reconnection request signal transmitted from the user terminal 3m at the reconnection timing (step S504), and connects the user terminal 3m to the measurement device 12c, which has become available (step S505).

### Specific Examples (Use Cases)

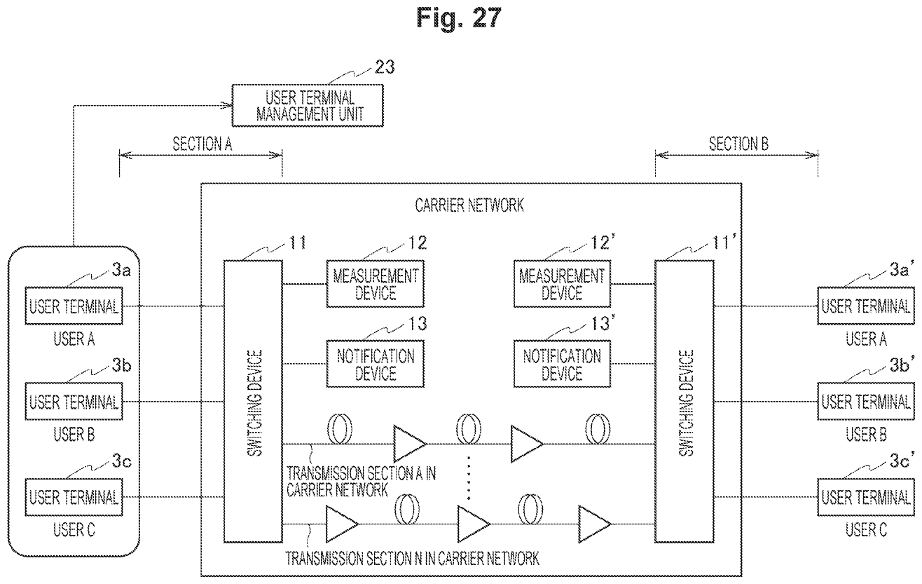

As illustrated in FIG. 27, users A to C are a group of users who have their own data centers outside the carrier network and can perform λ-connection via the carrier network. Since actual communication is performed in both directions, terminal authentication/transmission line quality estimation is performed in each of a section A and a section B. For simplicity, a specific example in the section A will be described. The same applies to the section B. Only one measurement device 12 and only one notification device 13 are disposed in the carrier on the section A side.

It is assumed that service level agreements (SLAs) of users A to C are SLA_A, SLA_B, and SLA_C and the priority of the connection request is higher as the priority of the SLA is higher. Here, it is assumed that SLA_A>SLA_B>SLA_C.

In the user terminal management unit 23, pieces of information (for example, a user number, a terminal ID, a line ID, the SLA, and a port number of the switching device 11 to which the user terminal is connected) of the user terminals 3a to 3c are registered.

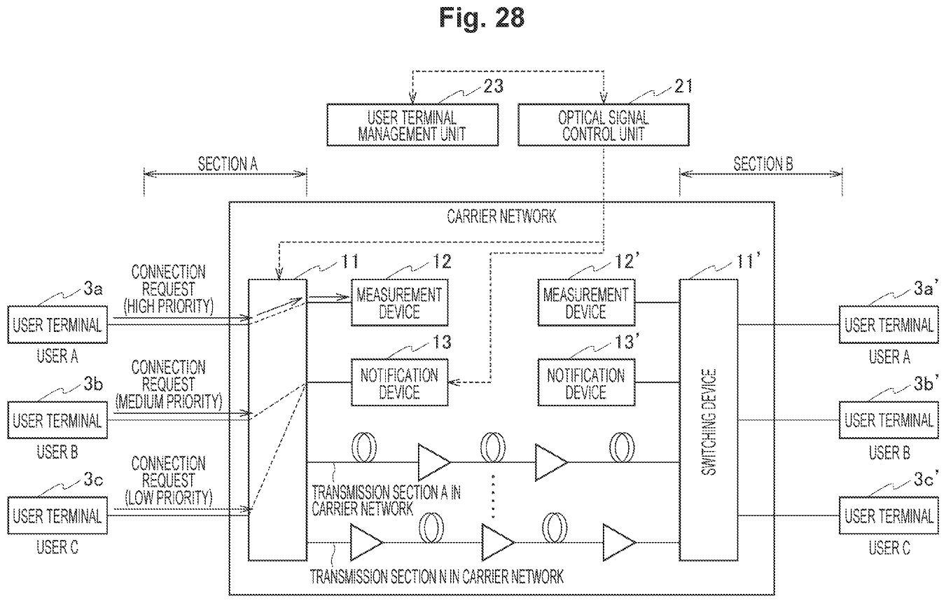

In order to prepare for a latest disaster, each of the users A to C connects the user terminals 3a to 3c to the carrier network to start data transmission for data backup. For this purpose, the user terminals 3a to 3c transmit connection requests to the carrier network (refer to FIG. 28).

First, the optical signal control unit 21 detects a connection request from each of the user terminals 3a to 3c, and determines the user terminal 3 to be connected to the measurement device 12. In the present embodiment, the optical signal control unit 21 determines the user terminal 3a having a highest SLA as the user terminal to be connected to the measurement device 12 first.

Thereafter, the optical signal control unit 21 connects the user terminal 3a to the measurement device 12 by referring to the user terminal management unit 23 and specifying the port number of the switching device 11 to which the user terminal 3a is connected. For the users B and C for whom connections to the measurement device 12 are not obtained, the optical signal control unit 21 temporarily connects the user terminals to the notification device 13, and causes the notification device 13 to notify the user terminals of the Busy signal and the retry timing, by respectively controlling the switching device 11 and the notification device 13.

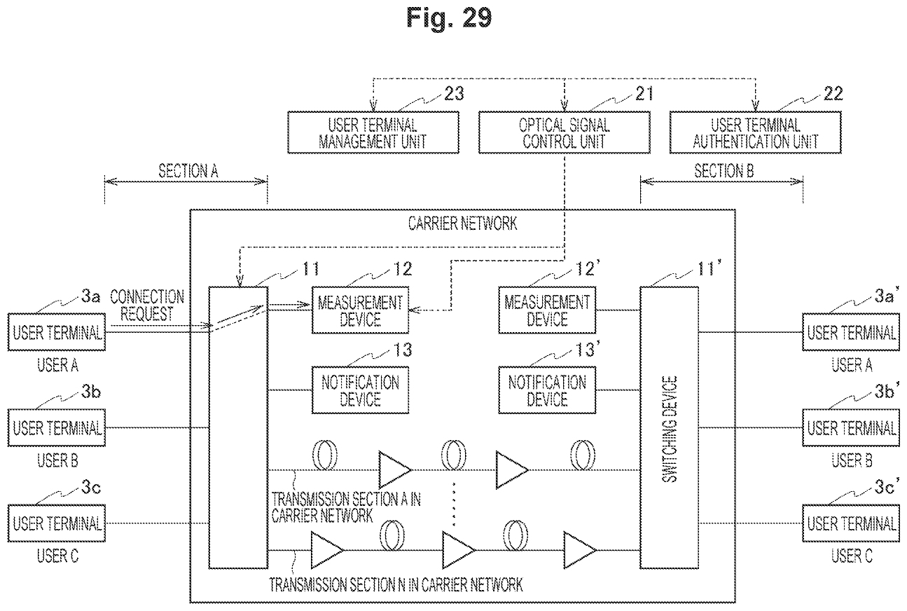

Next, the optical signal control unit 21 acquires the content of the connection request from the user terminal 3a arriving at the measurement device 12 and the information of the user terminal 3a, and transmits the acquired information to the user terminal authentication unit 22. The user terminal authentication unit 22 performs authentication by referring to the user terminal management unit 23 (refer to FIG. 29).

After authentication is performed, in a case where the user terminal is one permitted to be connected to the carrier network, the process proceeds to transmission line quality estimation processing. In a case where the user terminal is one not permitted to be connected, the optical signal control unit 21 blocks the optical signal by using the optical signal disconnection function of the switching device 11, and denies the connection to the carrier network. At this time, the notification device 13 may transmit a connection denial signal, and notify the user terminal that the connection request is denied.

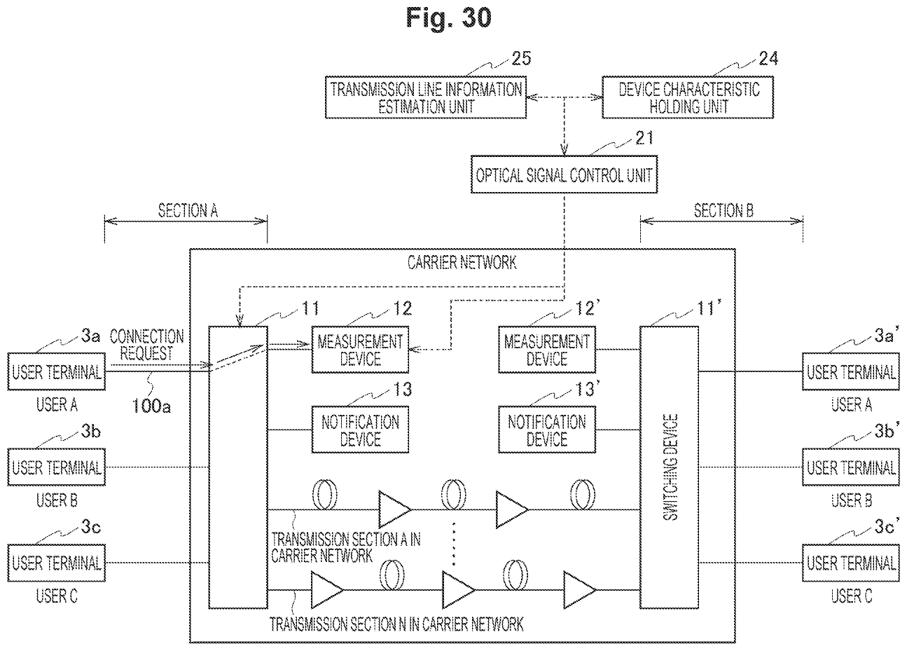

Next, the transmission line information estimation unit 25 estimates transmission quality of the transmission line 100a to which the user terminal 3a is connected (refer to FIG. 30). Specifically, the transmission line information estimation unit 25 inquires of the optical signal control unit 21 about the BER recorded in the measurement device 12, acquires the actual device characteristic of the measurement device 12 from the device characteristic holding unit 24, and estimates the transmission quality of the transmission line 100a in the section A in which the user terminal 3a and the carrier network are connected, by using these pieces of information.

A similar control sequence is also performed in the section B.

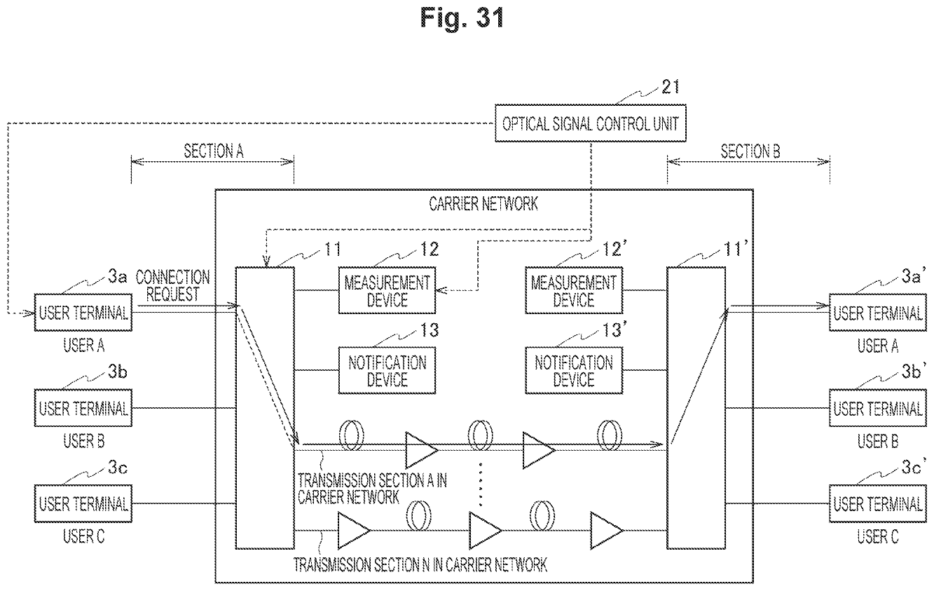

Next, the optical signal control unit 21 searches for a route that can be opened in the carrier network or a route that satisfies the user's request such as a band, and determines an appropriate route. In addition, the optical signal control unit 21 estimates the transmission quality of the determined route. The optical signal control unit 21 totals the transmission qualities of the transmission sections including the carrier network, and calculates an optimum transmission mode based on the total value. In addition, the optical signal control unit 21 sets the calculated transmission mode for the user terminal 3a, and notifies the user terminal 3a of the transmission mode. Finally, the optical signal control unit 21 opens the route through which the optical path in the carrier network passes (refer to FIG. 31). In addition, the optical signal control unit 21 provides an optimum optical path between the locations of the user A by controlling the switching device 11.

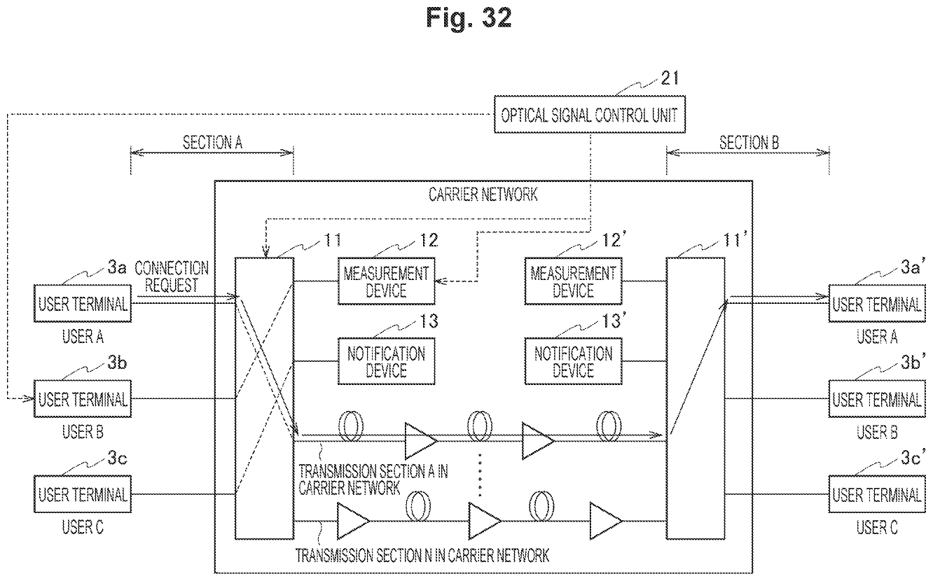

Thereafter, since the users B and C perform reconnection at the retry timing, the optical signal control unit 21 performs a procedure similar to that of the user A in order of the user B and the user C (refer to FIG. 32).

### Effects

According to the present embodiment, the optical signal control unit 21 of the control device 2 detects a connection request from a user terminal 3 on the connection device 1, and in a case where a measurement device 12 of the fixed number of measurement devices 12 is available, connects the user terminal 3 to the available measurement device 12. In a case where the fixed number of measurement devices 12 are not available, the optical signal control unit 21 temporarily connects the user terminal 3 to the notification device 13, and in a case where a measurement device 12 has become available, connects the user terminal 3 to the available measurement device 12. After the quality of the transmission line 100 is measured by the connected measurement device 12, the user terminal 3 is connected to the optical transmission network. Therefore, even in a case where there is an upper limit in the number of measurement devices 12, it is possible to automatically set many optical paths for a plurality of connection requests from one or more user terminals 3.

Further, according to the present embodiment, the optical signal control unit 21 of the control device 2 performs: a first congestion control method of connecting, in a case where none of the fixed number of measurement devices 12 is available, when there are a plurality of connection requests, the user terminal 3 to a measurement device 12 that has become available, in order of arrival of the connection requests or in order of priority of the connection requests; a second congestion control method of switching, in a state where none of the fixed number of measurement devices 12 is available, when there are a plurality of connection requests including a connection request in measurement of the quality of a transmission line, in a case where a priority of a new connection request is higher than a priority of the connection request in measurement of the quality of the transmission line, the connection destination of a measurement device 12 in measurement of the quality of the transmission line to a user terminal 3 of the new connection request; a third congestion control method of connecting, in a case where the connection request from the user terminal 3 is an urgent connection request, the user terminal 3 to a measurement device 12 that is used only in an emergency among the fixed number of measurement devices 12; a fourth congestion control method of connecting, in a case where none of the fixed number of measurement devices 12 is available, a user terminal 3 to a measurement device 12 that has become available, in order of the earliest transmission line quality measurement completion timing in each measurement device 12; and a fifth congestion control method of connecting, in a case where none of the fixed number of measurement devices 12 is available, a user terminal 3 to a measurement device 12 that has become available, in order of a designated timing of a reconnection request. Thereby, it is possible to automatically set an appropriate optical path.

### Others

The present invention is not limited to the above embodiment. The present invention can be modified in various manners within the gist of the present invention.

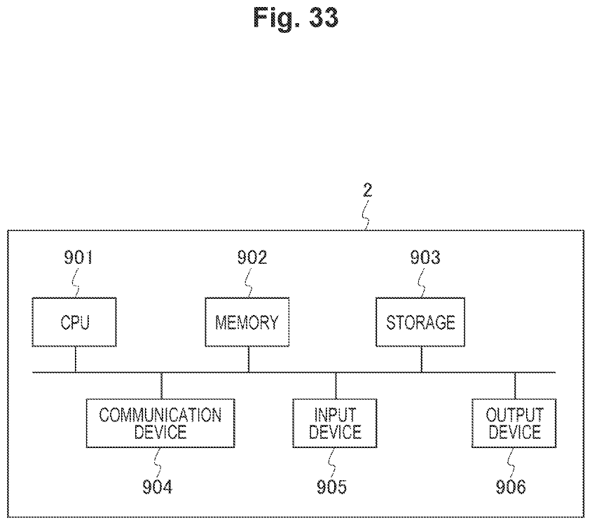

For example, as illustrated in FIG. 33, the control device 2 of the present embodiment described above can be implemented using a general-purpose computer system including a CPU 901, a memory 902, a storage 903, a communication device 904, an input device 905, and an output device 906. The memory 902 and the storage 903 are storage devices. In the computer system, each function of the control device 2 is implemented by the CPU 901 executing a predetermined program loaded on the memory 902.

The control device 2 may be implemented by a single computer. The control device 2 may be implemented by a plurality of computers. The control device 2 may be a virtual machine implemented on a computer. The program for the control device 2 can be stored in a computer-readable recording medium such as HDD, SSD, USB memory, CD, or DVD. The program for the control device 2 can also be distributed via a communication network.

### Reference Signs List

1 Connection device
11 Switching device
12 Measurement device
13 Notification device
2 Control device
21 Optical signal control unit
22 User terminal authentication unit
23 User terminal management unit
24 Device characteristic holding unit
25 Transmission line information estimation unit
26 Notification control unit
3 User terminal
4 Multiplexer
5 Demultiplexer
100 Transmission line
901 CPU
902 Memory
903 Storage
904 Communication device
905 Input device
906 Output device

1. An optical transmission system comprising:
a connection device that connects one or more user terminals to an optical transmission network for a carrier; and
a control device that controls the connection device, wherein
the connection device includes
a fixed number of measurement devices that measure a quality of a transmission line between the one or more user terminals and the connection device,
a notification device that notifies the one or more user terminals of busy information, and
a switching device that switches a connection destination of the one or more user terminals to any one of: one of the fixed number of measurement devices; the notification device; and the optical transmission network,
the control device includes a control unit, including one or more processors, that controls the switching device, and
the control unit detects a connection request from the one or more user terminals, and
in a case where a measurement device of the fixed number of measurement devices is available, connects the user terminal to the measurement device available,
in a case where none of the fixed number of measurement devices is available, temporarily connects the user terminal to the notification device, and when a measurement device of the fixed number of measurement devices has become available, connects the user terminal to the measurement device available, and
after the quality of the transmission line is measured by the measurement device connected, connects the user terminal to the optical transmission network.

2. The optical transmission system according to claim 1, wherein,
in a case where none of the fixed number of measurement devices is available, when there are a plurality of connection requests, the control unit connects the user terminal to a measurement device that has become available, in order of arrival of the connection requests, or in order of priority of the connection requests.

3. The optical transmission system according to claim 1, wherein,
in a case where none of the fixed number of measurement devices is available, and when there are a plurality of connection requests including a connection request in measurement of a quality of a transmission line, in a case where a priority of a new connection request is higher than a priority of the connection request in measurement of the quality of the transmission line, the control unit switches a connection destination of a measurement device in measurement of the quality of the transmission line to a user terminal of the new connection request.

4. The optical transmission system according to claim 1, wherein,
in a case where the connection request from the user terminal is an urgent connection request, the control unit connects the user terminal to a measurement device that is used only in an emergency among the fixed number of measurement devices.

5. The optical transmission system according to claim 1, wherein,
in a case where none of the fixed number of measurement devices is available, the control unit connects a user terminal to a measurement device that has become available, in order of the earliest transmission line quality measurement completion timing in each measurement device.

6. The optical transmission system according to claim 1, wherein,
in a case where none of the fixed number of measurement devices is available, the control unit connects a user terminal to a measurement device that has become available, in order of a designated timing of a reconnection request.

7. An optical path setting/congestion control method performed by a connection device that connects one or more user terminals to an optical transmission network for a carrier, and a control device that controls the connection device, wherein
the connection device includes
a fixed number of measurement devices that measure a quality of a transmission line between the one or more user terminals and the connection device,
a notification device that notifies the one or more user terminals of busy information, and
a switching device that switches a connection destination of the one or more user terminals to any one of: one of the fixed number of measurement devices; the notification device; and the optical transmission network,
the control device includes a control unit, including one or more processors, that controls the switching device, and the method causing the control unit to execute:
detecting a connection request from the one or more user terminals, and
in a case where a measurement device of the fixed number of measurement devices is available, connecting the user terminal to the measurement device available,
in a case where none of the fixed number of measurement devices is available, temporarily connecting the user terminal to the notification device, and when a measurement device of the fixed number of measurement devices has become available, connecting the user terminal to the measurement device available, and
after the quality of the transmission line is measured by the measurement device connected, connecting the user terminal to the optical transmission network.

8. The optical path setting/congestion control method according to claim 7, the method causing the control unit to execute:
connecting, in a case where none of the fixed number of measurement devices is available, when there are a plurality of connection requests, the user terminal to a measurement device that has become available, in order of arrival of the connection requests or in order of priority of the connection requests;
switching, in a state where none of the fixed number of measurement devices is available, when there are a plurality of connection requests including a connection request in measurement of a quality of a transmission line, in a case where a priority of a new connection request is higher than a priority of the connection request in measurement of the quality of the transmission line, a connection destination of a measurement device in measurement of the quality of the transmission line to a user terminal of the new connection request;
connecting, in a case where the connection request from the user terminal is an urgent connection request, the user terminal to a measurement device that is used only in an emergency among the fixed number of measurement devices;
connecting, in a case where none of the fixed number of measurement devices is available, a user terminal to a measurement device that has become available, in order of the earliest transmission line quality measurement completion timing in each measurement device; or
connecting, in a case where none of the fixed number of measurement devices is available, a user terminal to a measurement device that has become available, in order of a designated timing of a reconnection request.
